(19) United States
(12) Patent Application Publication
(10) Pub. No.: US 2025/0138446 A1
(43) Pub. Date: May 1, 2025

(54) TECHNOLOGY TO COLLECT OR REMOVE FOREIGN MATTER OR UNWANTED SUBSTANCES USING ELECTROSTATIC ADSORPTION

(71) Applicant: CANON KABUSHIKI KAISHA, Tokyo (JP)

(72) Inventors: TOMOAKI NAKAI, Shizuoka (JP); YUKI NISHIZAWA, Kanagawa (JP); JUNICHI SEKIYAMA, Tokyo (JP)

(21) Appl. No.: 18/928,717

(22) Filed: Oct. 28, 2024

(30) Foreign Application Priority Data
Oct. 31, 2023 (JP) 2023-186953

(51) Int. Cl. G03G 15/02; G03G 15/16

(52) U.S. Cl. CPC G03G 15/0225; G03G 15/166

(57) ABSTRACT

A capturing rotation member captures an object on a surface by static electricity. A charging rotation member rotates while contacting with the capturing rotation member and triboelectrically charges a surface of the capturing rotation member. A collecting rotation member rotates while contacting with the capturing rotation member and collects the object adhering to the surface of the capturing rotation member. The capturing rotation member and the charging rotation member rotate in the same direction. The capturing rotation member and the collecting rotation member rotate in opposite directions.

### BACKGROUND OF THE DISCLOSURE

### Field of the Disclosure

The present disclosure relates to technology to collect or remove foreign matter or unwanted substances using electrostatic adsorption.

### Description of the Related Art

At present, in various manufacturing facilities or industrial products, technologies for recovering or removing foreign matters or unnecessary substances using an electrostatic attraction force have been developed. According to Japanese Patent No. 4886097, there is disclosed a technique for recovering or removing foreign matters adhering to a surface of a glass substrate, a printed circuit board, a film, a sheet, or a plastic plate by an electrostatic attraction force. According to Japanese Patent Laid-Open No. 2017-156450, there is disclosed an image forming apparatus for recovering or removing paper dust adhering to a surface of paper by an electrostatic attraction force. According to Japanese Patent Laid-Open No. 2007-132999, a brush that adsorbs toner adhering to a surface of a photoreceptor, a collection roller that collects toner from the brush, and a cleaning blade that removes toner from the collection roller are disclosed.

In the related art, a power supply device that applies a high voltage to a collecting member that collects an object to be captured and a high breakdown voltage wiring that supplies a high voltage to the collecting member are required.

### SUMMARY OF THE DISCLOSURE

The present disclosure provides a cleaning device including a capturing rotation member that is rotatable and configured to capture an object to be captured on a surface to be cleaned by static electricity, a charging rotation member that rotates while being in contact with the capturing rotation member and configured to triboelectrically charge a peripheral surface of the capturing rotation member, and a collecting rotation member that rotates while in contact with the capturing rotation member and configured to collect the object to be captured that adheres to the peripheral surface of the capturing rotation member. In a rotational direction of the capturing rotation member, the capturing rotation member contacts the surface to be cleaned at a first position. In the rotational direction of the capturing rotation member, the capturing rotation member and the collecting rotation member are in contact at a second position. In the rotational direction of the capturing rotation member, the capturing rotation member and the charging rotation member are in contact at a third position. The first position, the second position, and the third position along the rotational direction of the capturing rotation member are arranged in order, the rotational direction of the capturing rotation member is the same as a rotational direction of the charging rotation member, and the rotational direction of the capturing rotation member is opposite to a rotational direction of the collecting rotation member.

Further features of the present disclosure will become apparent from the following description of exemplary embodiments (with reference to the attached drawings).

### BRIEF DESCRIPTION OF THE DRAWINGS

FIG. 1 is a diagram illustrating an image forming apparatus.

FIG. 2 is a diagram illustrating a cleaning device.

FIG. 3 is a diagram illustrating a triboelectric series.

FIG. 4 is a diagram illustrating an experimental result (evaluation result);

FIG. 5 is a diagram illustrating an image forming apparatus according to a second embodiment.

FIG. 6 is a diagram illustrating a cleaning device according to a second embodiment;

FIG. 7 is a diagram illustrating an image forming apparatus according to a third embodiment.

FIG. 8 is a diagram illustrating a cleaning device according to a third embodiment.

FIG. 9 is a diagram illustrating a cleaning device according to a fourth embodiment.

FIG. 10 is a diagram illustrating a cleaning device according to a fourth embodiment.

FIG. 11 is a diagram illustrating a cleaning device according to a fourth embodiment.

FIG. 12 is a diagram illustrating a cleaning device according to a fourth embodiment.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

### First Embodiment

In the first embodiment, a cleaning device mounted on an image forming apparatus is described. The cleaning devices are used, for example, to clean developing materials (e.g., toner) used to form images in the image forming apparatus.

### (1) Structure of Image Forming Apparatus

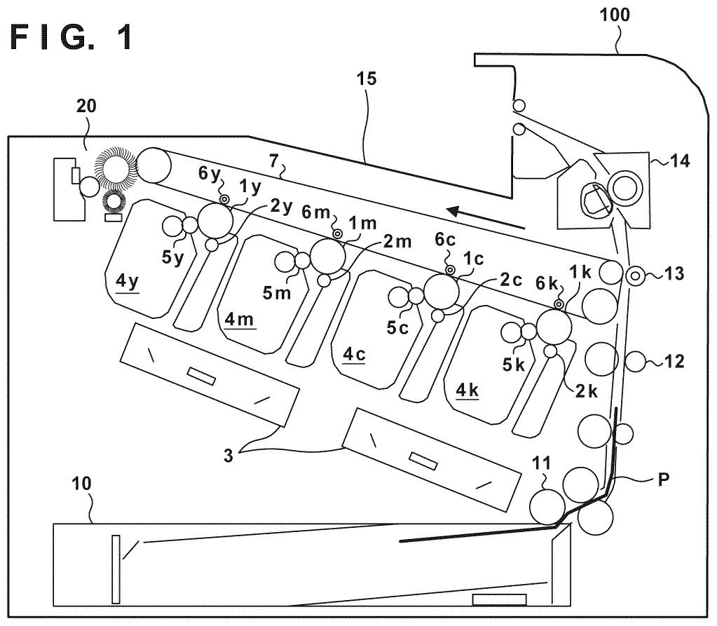

FIG. 1 illustrates an image forming apparatus 100 for forming full color images in an electrophotographic manner. The lower case letters at the end of the reference numeral indicate a color of toner (yellow “y”, magenta “m”, cyan “c”, black “k”). When matters common to four colors are described, letters “y”, “m”, “c”, “k” from the reference numerals may be omitted.

A photosensitive drum 1 is an image carrier that carries an electrostatic latent image or a toner image, and rotates in a predetermined direction. A charging member 2 is a charger (e.g., a charging roller or a metallic wire) that uniformly charges a surface of the photosensitive drum 1. An exposure device 3 exposes a surface of the photosensitive drum 1 with a laser beam to form an electrostatic latent image according to image data.

A developing device 4 contains toner and supplies the toner to the electrostatic latent image via the developing roller 5. As a result, the electrostatic latent image is developed to form a toner image. A primary transfer roller 6 transfers the toner image from the photosensitive drum 1 to an intermediate transfer belt 7. The intermediate transfer belt 7 is an endless intermediate transfer member. The yellow, magenta, cyan, and black toner images are sequentially transferred onto the intermediate transfer belt 7 to form a full-color toner image. When the intermediate transfer belt 7 rotates, the toner images are conveyed to a secondary transfer unit. The secondary transfer unit is formed by the intermediate transfer belt 7 and a secondary transfer roller 13.

A sheet cassette 10 is a storage box for storing and holding a large number of sheets P. A feeding roller 11 feeds the sheets P one by one from the sheet cassette 10.

When the sheet P comes into contact with a registration roller 12, skew of the sheet P is corrected. The registration roller 12 conveys the sheet P to the secondary transfer unit.

In the secondary transfer unit, the secondary transfer roller 13 transfers the toner image from the intermediate transfer belt 7 to the sheet P. A fixing unit 14 fixes the toner image on the sheet P by applying heat and pressure to the toner image and the sheet P.

Thereafter, the sheet P is discharged onto a discharge tray 15.

However, even after the secondary transfer is completed, a part of a surface of the toner may remain on the intermediate transfer belt 7. Therefore, the cleaning device 20 cleans and collects the toner remaining on the surface of the intermediate transfer belt 7.

### (2) Cleaning Device Structure

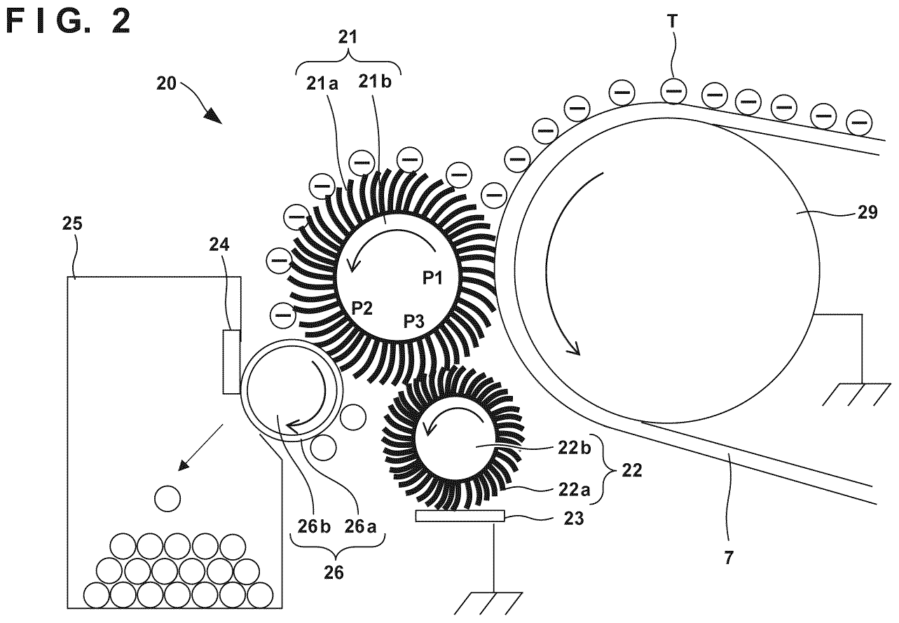

As shown in FIG. 2, a cleaning device 20 collects the toner T adhering to the intermediate transfer belt 7. The intermediate transfer belt 7 is suspended by a suspension roller 29 and is rotated in an arrow direction. The suspension roller 29 is formed of a conductor such as aluminum, for example. The suspension roller 29 is grounded to a frame ground (GND) through a main body frame and an earth cable.

The cleaning device 20 includes a capturing roller 21, a charging roller 22, a charge eliminating sheet 23, a collecting roller 26, a blade 24, and a container 25. The capturing roller 21 includes a capturing brush 21a and a core member 21b. The capturing brush 21a is held on the core member 21b. The capturing roller 21 rotates with the core member 21b rotatably supported by the main body frame as a rotating shaft.

The capturing roller 21 is in contact with the intermediate transfer belt 7 at the contact position P1. The capturing roller 21 is in contact with the collecting roller 26 at the contact position P2. The capturing roller 21 is in contact with the charging roller 22 at the contact position P3. In a rotational direction of the capturing roller 21, the contact position P1 is upstream of the contact position P2, and the contact position P2 is upstream of the contact position P3. That is, the contact position P1, the contact position P2, and the contact position P3 are arranged in order along the rotational direction of the capturing roller 21.

The charging roller 22 includes a charging brush 22a and a core member 22b. The charging brush 22a is held on the core member 22b. The charging roller 22 rotates with the core member 22b rotatably supported by the main body frame as a rotating shaft. The charging roller 22 triboelectrically charges a surface of the capturing roller 21 while rotating.

The collecting roller 26 has a surface layer 26a and a core member 26b. The surface layer 26a is held on the core member 26b. The collecting roller 26 rotates with the core member 26b rotatably supported by the main body frame as a rotating shaft.

### (3) Rotational Direction

As shown in FIG. 2, the capturing roller 21 rotates counterclockwise. The collecting roller 26 rotates clockwise. The charging roller 22 also rotates counterclockwise. Here, when attention is paid to two rotation member that are in contact with each other, a contact portion of the capturing roller 21 and the contact portion of the collecting roller 26 move in the same direction (forward direction) with each other. On the other hand, a contact portion of the capturing roller 21 and the contact portion of the charging roller 22 move in opposite directions.

### (4) Material of the Capturing Roller

The capturing brush 21a has a number of piles. The material of the pile is, for example, polyethylene terephthalate (PET). A pile fineness is, for example, 10D.

A pile length is, for example, 5 mm. A density is 30 kF/inch\hat{ }2. An outer diameter of the capturing roller 21 is, for example, 30 mm. A shaft rotational velocity is, for example, 50 rpm. In this case, a surface moving velocity of the capturing roller 21 is 78.5 mm/s.

### (5) Material of the Collection Roller

The material of the surface layer 26a of the collecting roller 26 is, for example, nylon. A thickness is, for example, 0.5 mm. An outer diameter of the collecting roller 26 is, for example, 24 mm. A shaft rotational velocity is, for example, 80 rpm. In this case, a surface moving velocity of the collecting roller 26 is 100.5 mm/s. The surface moving velocity of the collecting roller 26 is greater than the surface moving velocity of the capturing roller 21.

### (6) Material of the Charging Roller

A material of a pile of the charging brush 22a of the charging roller 22 is, for example, perfluoroalkoxy fluororesin (PFA). A pile fineness is, for example, 10D.

A pile length is, for example, 3 mm. A pile density is, for example, 50 kF/inch\hat{ }2.

An outer diameter of the charging roller 22 is, for example, 18 mm. A shaft rotational velocity is then 30 rpm. In this case, the surface moving velocity of the charging roller 22 is 28.7 mm/s.

### (7) Toner Collection Process and Materials for Each Component

### (7-1) From the Intermediate Transfer Belt to the Capturing Roller

Here, an object to be captured is toner T. The toner T remaining on the surface of the intermediate transfer belt 7 is collected in the container 25 through the following process. The toner T is charged to a negative polarity by an external additive for controlling chargeability. Therefore, it is sufficient that the surface of the capturing roller 21 is positively charged in order to collect the toner T. The capturing roller 21 collects the toner T on the intermediate transfer belt 7 by electrostatic attraction.

### (7-2) From Capturing Roller to Collection Roller

The toner T adsorbed on the capturing roller 21 is transferred from the capturing roller 21 to the collecting roller 26. The condition for promoting the transfer is that the collecting roller 26 is charged to the positive side with respect to the capturing roller 21. As a result, an electrostatic attraction force is generated from the capturing roller 21 toward the collecting roller 26, and the toner T moves from the capturing roller 21 to the collecting roller 26.

In the first embodiment, a rubbing charge is generated between a plurality of members (rotating bodies) without using an external power source. As a result, the charging polarity and the charging amount are controlled. In general, the charging polarity and the amount of charge are determined by the triboelectric series. When two physical materials are triboelectrically charged, one of the two physical materials is positively charged and the other is negatively charged. The charge polarity and the charge amount depend on materials (chemical abundance) of the two physical materials. The triboelectric series is made by arranging various materials based on the relative ease of charging. In the triboelectric series, the farther the two materials are, the greater the charge amount.

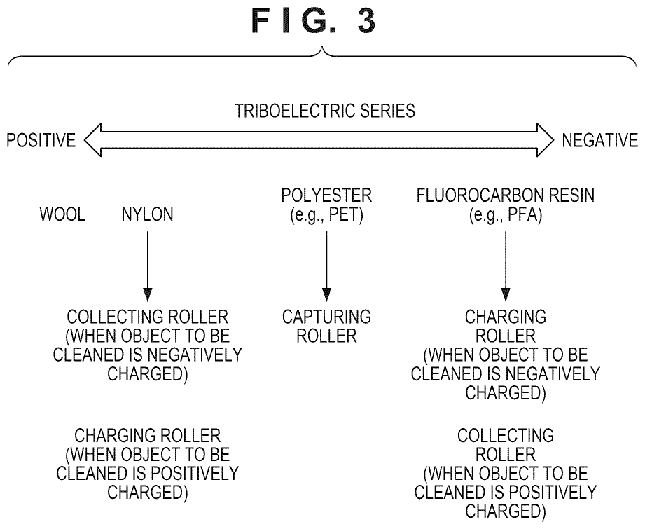

FIG. 3 shows an example of a triboelectric series. In order to collect and transfer the negatively charged toner T, the surface layer 26a of the collecting roller 26 needs to be positioned more positively than the capturing brush 21a in the triboelectric series. The capturing brush 21a should be located more positive than the charging brush 22a. That is, in the triboelectric series, the surface layer 26a of the collecting roller 26, the capturing brush 21a, and the charging brush 22a need to be arranged in this order from the positive side to the negative side. In other words, the surface layer 26a of the collecting roller 26 is more likely to be charged to the positive side than the capturing brush 21a, and the capturing brush 21a is more likely to be charged to the positive side than the charging brush 22a. In other words, the charging brush 22a is more likely to be charged to the negative side than the capturing brush 21a, and the capturing brush 21a is more likely to be charged to the negative side than the surface layer 26a of the collecting roller 26. In the triboelectric series, which of the two materials is on the positive side can be confirmed by rubbing the two materials and measuring their polarity with a surface electrometer.

As a material of the surface layer 26a of the collecting roller 26, wool, nylon, rayon, or the like, which is positively located in the triboelectric series, may be employed. In the first embodiment, nylon was adopted as a material of the surface layer 26a of the collecting roller 26.

As a material of the charging brush 22a, a negative fluororesin can be used in the triboelectric series. Fluorocarbon resins include, for example, polytetrafluoroethylene (PTFE), silicon, polychlorotrifluoroethylene (PCTFE, CTFE), polyvinylidene fluoride (PVDF), polyvinyl fluoride (PVF), PFA, tetrafluoroethylene-hexafluoride polypropylene copolymer (FEP), ethylene-tetrafluoroethylene copolymer (ETFE), and ethylene-cyclotrifluoroethylene copolymer (ECTFE). In the first embodiment, PFA was adopted as a material of the charging brush 22a.

A material of the capturing brush 21a may be any material that is between nylon and PFA in the triboelectric series. Therefore, PET was adopted in the first embodiment.

As shown in FIG. 2, a charge eliminating sheet 23 is disposed so as to be contacted with the charging brush 22a. The material of the charge eliminating sheet 23 is a conductive sheet or plate. The charge eliminating sheet 23 is grounded to the GND such as the main body frame that is not biased.

Accordingly, the electric charges charged in the charging brush 22a are directed toward the GND by rubbing between the capturing brush 21a and the charging brush 22a. When the charging roller 22 rubs again against the capturing brush 21a by rotating the charging roller 22, the charge amount of the charging roller 22 increases more than the charge amount of the capturing brush 21a. When compared with the charge amount of the capturing brush 21a in the absence of the charge eliminating sheet 23, the charge amount of the capturing brush 21a in the presence of the charge eliminating sheet 23 is increased.

As a material of a blade 24, for example, an elastic polyurethane resin is employed. As a result, the blade 24 scrapes off the toner T adhering to the collecting roller 26 and collects the toner T in the container 25. The collected toner T is accumulated in the container 25.

### (8) Verification of the Effect

The cleanabilities of the intermediate transfer belt 7 were evaluated for the first embodiment, Comparative Examples 1 to 2, and Modification Examples 1 to 4.

Differences between the first embodiment, Comparative Examples 1 to 2, and Modification Examples 1 to 4 are as follows.

Comparative Example 1: The direction of rotation of the collecting roller 26 is changed counterclockwise. The contact portion of the capturing roller 21 and the contact portion of the collecting roller 26 move in opposite directions.

Comparative Example 2: The rotational direction of the charging roller 22 is changed clockwise. The contact portion of the capturing roller 21 and the contact portion of the charging roller 22 move in the forward direction.

Modification Example 1: The capturing roller 21 is changed to a solid roller. Note that the outer diameter of the capturing roller 21 is not changed. Note that the outermost layer of the capturing roller 21 is PET, and the thickness thereof is 0.5 mm. An intermediate layer of foamed silicone rubber is inserted as an elastic layer between the outermost layer and the core member 21b.

Modification Example 2: The charging roller 22 is changed to a solid roller.

The outer diameter of the charging roller 22 is not changed. The material of the outermost layer of the charging roller 22 is PFA. Its thickness is 0.5 mm. An intermediate layer of foamed silicone rubber is inserted as an elastic layer between the outermost layer and the core member 21b.

Modification Example 3: The shaft rotational velocity of the collecting roller 26 is changed to 50 rpm. The surface moving velocity of the collecting roller 26 is 62.8 mm/s. This is lower than the surface moving velocity 78.5 mm/s of the capturing roller 21.

Modification Example 4: The charge eliminating sheet 23 is deleted.

Evaluation of cleanability was performed as follows. An image was formed on 1000 sheets P using yellow and magenta. The sheets P were A4 sized GF-C081 paper (manufactured by Canon Co., Ltd.). Here, the yellow density and the magenta density were 100%, respectively. A loading amount of the toner was 1.0 mg/cm\hat{ }2. When the image formation on the 1000 sheets P was completed, the state of collection of the toner T by the cleaning device 20 was confirmed. As a reference, when an image formed by superimposing two colors of toner is continuously printed on 1000 sheets P, the amount of toner remaining on the intermediate transfer belt 7 increases. That is, the cleaning condition is severe for the cleaning device 20.

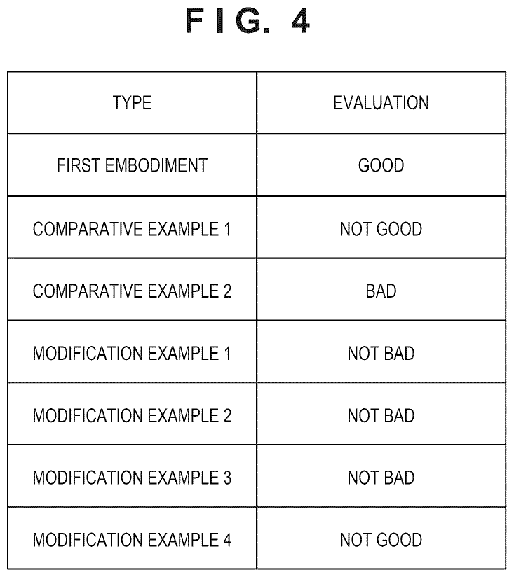

FIG. 4 shows experimental results (evaluation results). In FIG. 4, “GOOD” refers to a state in which there is no cleaning failure. The cleaning failure refers to, for example, that streak-shaped toner remains on the surface of the intermediate transfer belt 7 that has passed through the cleaning device 20. “NOT BAD” means that several streaks have been confirmed at the time of completion of printing on 100 sheets P. “NOT GOOD” means that several streaks have been confirmed at the time of completion of printing on 50 sheets P. “BAD” means that several streaks have been confirmed at the time of completion of printing on the ten sheets P.

In Comparative Example 1, the moving direction of the contact portion of the capturing roller 21 and the moving direction of the contact portion of the collecting roller 26 were opposite each other. Therefore, in a nip region formed by the contact between the capturing roller 21 and the collecting roller 26, the opportunity (time) for the toner T adhering to the capturing roller 21 to adhere to the collecting roller 26 is reduced. Therefore, it is considered that the transferability to the collecting roller 26 is lowered, the toner T remaining in the capturing roller 21 is increased, and the cleaning failure is increased. Therefore, if the moving direction of the contact portion of the capturing roller 21 and the moving direction of the contact portion of the collecting roller 26 are in the forward direction, the cleaning effect is improved.

In Comparative Example 2, the moving direction of the contact portion of the capturing roller 21 and the moving direction of the contact portion of the charging roller 22 were the same. Therefore, the charge amount of the capturing roller 21 due to the triboelectric charge is reduced. As a result, it is considered that the recoverability of the toner Tis deteriorated and a cleaning failure occurs. Therefore, if the moving direction of the contact portion of the capturing roller 21 is opposite to the moving direction of the contact portion of the charging roller 22, the cleaning effect is improved.

In Modification Example 1, the capturing roller 21 is changed from the brush roller to the solid roller. Therefore, the surface area of the capturing roller 21 is greatly reduced, and the occasion of the capturing roller 21 coming into contact with the toner T on the intermediate transfer belt 7 is reduced. As a result, it is considered that the recoverability of the toner T is deteriorated and a cleaning failure occurs. Therefore, if the capturing roller 21 is a brush roller, the cleaning effect is improved.

In Modification Example 2, the charging roller 22 is changed from the brush roller to the solid roller. Thus, the occasion of contact with the toner is reduced. It is considered that the amount of charge of the capturing roller 21 caused by the triboelectric charge decreases, the recoverability of the toner T decreases, and the cleaning failure occurs. Therefore, if the charging roller 22 is a brush roller, the cleaning effect is improved.

In Modification Example 3, the surface moving velocity of the capturing roller 21 is higher than the surface moving velocity of the collecting roller 26. The surface movement area per unit time of the collecting roller 26 is smaller than the surface movement area per unit time of the capturing roller 21. Therefore, it is considered that the transfer efficiency of the toner T from the capturing roller 21 to the collecting roller 26 is lowered, and thus a cleaning failure has occurred. Therefore, if the surface moving velocity of the collecting roller 26 is greater than the surface moving velocity of the capturing roller 21, the cleaning effect is improved.

In Modification Example 4, the charge eliminating sheet 23 is omitted. Therefore, the charging roller 22 is charged up, and the charge amount of the capturing roller 21 due to the triboelectric charge gradually decreases. As a result, it is considered that the recoverability of the toner T is deteriorated and a cleaning failure occurs. Therefore, the cleaning effect is improved by disposing the charge eliminating sheet 23 with respect to the charging roller 22.

In the first embodiment, the moving direction of the contact portion of the capturing roller 21 and the moving direction of the contact portion of the charging roller 22 are opposite each other. The capturing roller 21 is a brush roller. The charging roller 22 is a brush roller. As a result, the amount of charge of the capturing roller 21 caused by the triboelectric charge increases. The moving direction of the contact portion of the capturing roller 21 and the moving direction of the contact portion of the collecting roller 26 are the same. This increases the occasion that the toner T adhering to the capturing roller 21 adheres to the collecting roller 26, and improves the transferability to the collecting roller 26. The surface moving velocity of the capturing roller 21 is smaller than the surface moving velocity of the collecting roller 26. That is, the moving area of the collecting roller 26 per unit time is relatively large. Therefore, the transferability of the toner from the capturing roller 21 to the collecting roller 26 is improved. When the charge eliminating sheet 23 is adopted, charge-up of the charging roller 22 is suppressed, and the amount of charge of the capturing roller 21 due to triboelectric charging increases. Thus, the first embodiment was able to maintain better cleanability than the other Comparative Examples.

In the first embodiment, the peripheral surface of the intermediate transfer belt 7 is adopted as the surface to be cleaned. However, this is only an example. The surface to be cleaned may be a transfer material conveyance member that sucks and conveys the sheet P as a transfer material.

### Second Embodiment

### (1) Overview

In the second embodiment, an image forming apparatus 500 for forming monochrome images using an electrophotographic manner is described. Further, toner T remaining on photosensitive drum 1, which is an image carrier, is collected by the cleaning device 20.

### (2) Structure of the Image Forming Apparatus

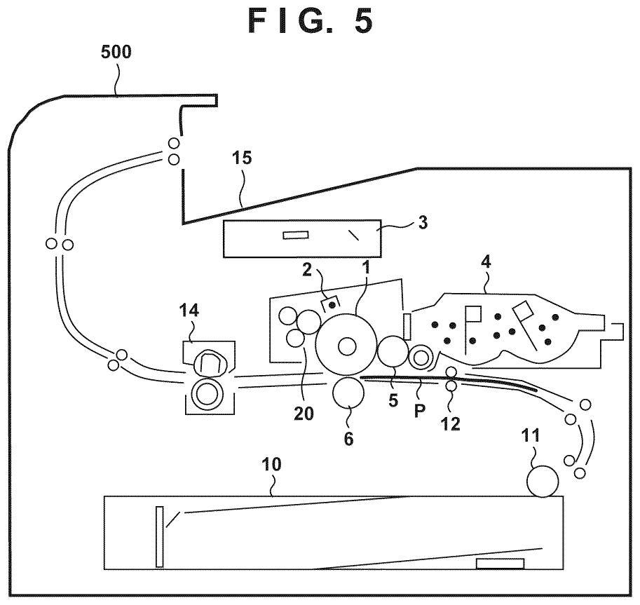

FIG. 5 shows structure of the image forming apparatus 500 of the second embodiment. In FIG. 5, the same reference numerals are given to the same matters as those in FIG. 1, and the description thereof will be omitted. Although the intermediate transfer belt 7 is employed in FIG. 1, the intermediate transfer belt 7 is omitted in FIG. 5. Thus, primary transfer roller 6 transfers toner images from the photosensitive drum 1 to the sheet P.

### (3) Cleaning Device

As shown in FIG. 5, the cleaning device 20 is arranged to touch the photosensitive drum 1 in order to collect the toner T remaining on the photosensitive drum 1.

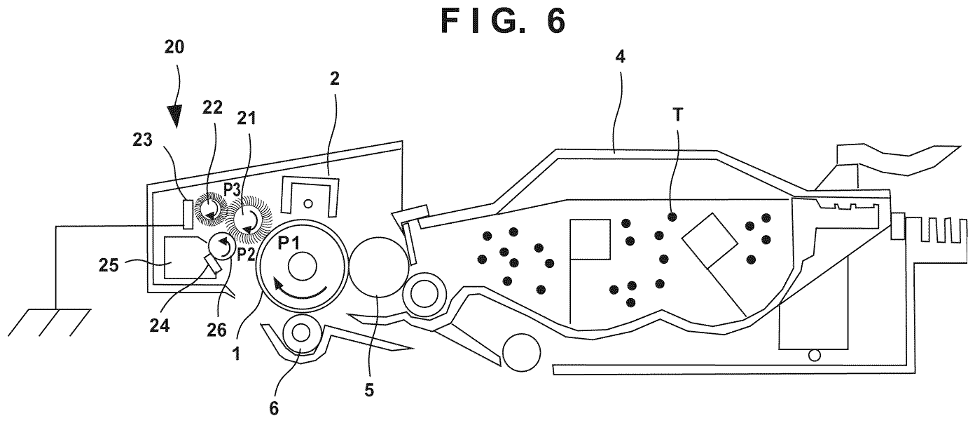

FIG. 6 shows the structure of the cleaning device 20 of the second embodiment. The structure of the cleaning device 20 of the second embodiment is basically the same as the structure of the cleaning device 20 of the first embodiment. The capturing roller 21 is disposed so as to face the photosensitive drum 1 to be cleaned. The charging roller 22 is disposed so as to face the capturing roller 21, and triboelectrically charges the capturing roller 21. The collecting roller 26 is disposed so as to face the capturing roller 21, and collects the toner T from the capturing roller 21 to the collecting roller 26. The charge eliminating sheet 23 is disposed so as to contact the charging roller 22, and the electric charges of the charging roller 22 are released to the GND. The charge eliminating sheet 23 is connected to the frame ground (GND). The blade 24 collects the toner T from the collecting roller 26 to the container 25.

As described in the first embodiment, the toner T is negatively charged. Therefore, the structure of the cleaning device 20 of the second embodiment is the same as that of the cleaning device of the first embodiment.

As shown in FIG. 6, the rotational direction of the capturing roller 21 is clockwise. The direction of rotation of the collecting roller 26 is counterclockwise.

The rotational direction of the charging roller 22 is clockwise. That is, the moving direction of the contact portion of the capturing roller 21 and the moving direction of the contact portion of the collecting roller 26 are the same. The moving direction of the contact portion of the capturing roller 21 and the moving direction of the contact portion of the charging roller 22 are opposite each other. Therefore, the condition of the rotational direction in the second embodiment corresponds to the condition of the rotational direction in the first embodiment.

In the second embodiment, the capturing roller 21 is a brush roller. The material of the brush is, for example, PET. The material of the surface layer of the collecting roller 26 is, for example, nylon. The charging roller 22 is also a brush roller. The material of the brush is, for example, PFA.

Therefore, the cleaning effect in the second embodiment is expected to be equivalent to the cleaning effect in the first embodiment. Consequently, a simpler cleaning device 20 can be realized without adopting a dedicated high-voltage power supply (charging power supply) for the cleaning device 20.

### Third Embodiment

### (1) Overview

In the third embodiment, paper dust of a sheet P is actively collected prior to the sheet P passing through photosensitive drum 1. As a result, the amount of paper dust adhering to photosensitive drum 1 is reduced, and the generation of an image defect is suppressed. In the third embodiment, components substantially the same as or similar to those in the second embodiment are given the same reference numerals, and description thereof will be omitted.

### (2) Image Forming Apparatus

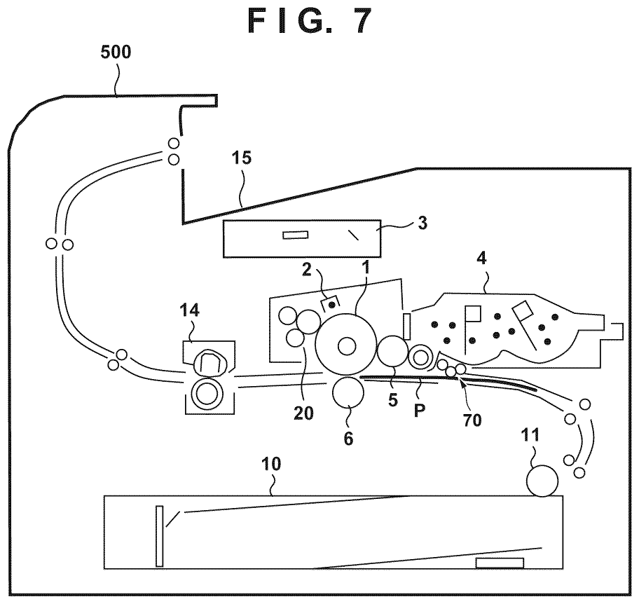

FIG. 7 shows an image forming apparatus 500 of the third embodiment. A cleaning device 70 is disposed upstream of the photosensitive drum 1 and the primary transfer roller 6 in a conveyance direction of the sheet P. The cleaning device 70 is a device that cleans and collects paper dust adhering to the sheet P.

### (3) Cleaning Device

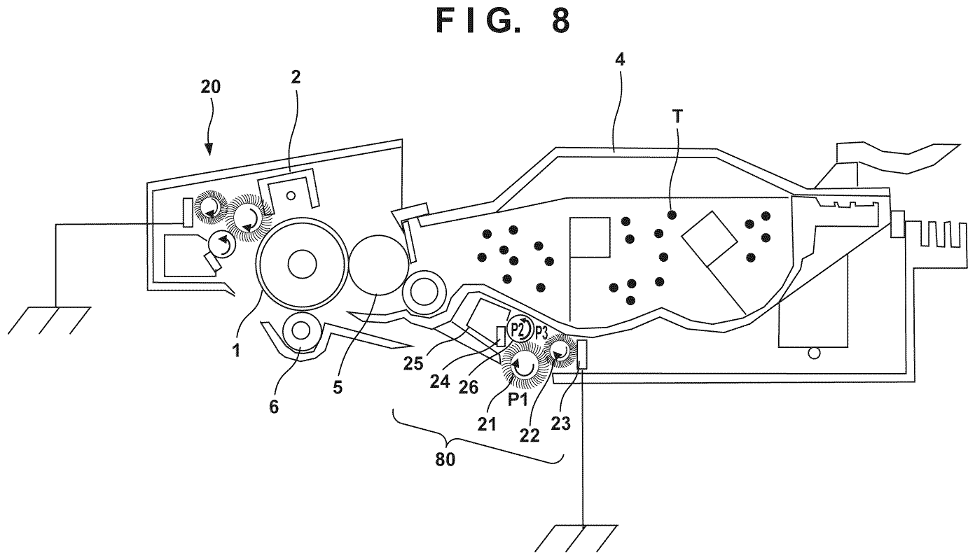

FIG. 8 shows structure of the developing device 4 in the third embodiment. The cleaning device 70 is provided on a lower surface side of the developing device 4 so as to face the conveyance path of the sheet P. Like the cleaning device 20, the cleaning device 70 includes the capturing roller 21, the charging roller 22, the charge eliminating sheet 23, the collecting roller 26, the blade 24, and the container 25. The container 25 is a paper dust container for storing the paper dust collected from the sheet P.

The capturing roller 21 is disposed so as to face the sheet P to be cleaned. The charging roller 22 is disposed so as to face the capturing roller 21, and triboelectrically charges the capturing roller 21. The collecting roller 26 is disposed so as to face the capturing roller 21, and collects paper dust from the capturing roller 21 to the collecting roller 26. The charge eliminating sheet 23 is disposed so as to contact the charging roller 22, and the electric charges of the charging roller 22 are released to the GND. The charge eliminating sheet 23 is connected to the frame ground (GND). The blade 24 collects paper dust from the collecting roller 26 to the container 25.

As shown in FIG. 8, the rotational direction of the capturing roller 21 is clockwise. The direction of rotation of the collecting roller 26 is counterclockwise.

The rotational direction of the charging roller 22 is clockwise. That is, the moving direction of the contact portion of the capturing roller 21 and the moving direction of the contact portion of the collecting roller 26 are the same. The moving direction of the contact portion of the capturing roller 21 and the moving direction of the contact portion of the charging roller 22 are opposite each other. Therefore, the condition of the rotational direction in the third embodiment corresponds to the condition of the rotational direction in the first and second embodiments.

In the third embodiment, it is necessary to reduce stress caused by rubbing between the sheet P and the capturing roller 21. Therefore, the rotational direction of the capturing roller 21 is set so that the movement direction of the capturing roller 21 with respect to the sheet P coincides with the conveyance direction of the sheet P.

In the first and second embodiments, the cleaning device 20 collects the negatively charged toner T. The cleaning device 70 of the third embodiment collects the paper dust of the sheet P. The paper dust is generally positively charged. Therefore, the charging polarity of the cleaning object of the third embodiment is opposite to the charging polarity of the cleaning objects of the first and second embodiments.

Therefore, in the third embodiment, these materials are selected so that the material of the collecting roller 26, the material of the capturing roller 21, and the material of the charging roller 22 are arranged from the negative side toward the positive side in the triboelectric series. In the third embodiment, for example, the capturing roller 21 is a brush roller. The brush material is PET. The material of the surface layer of the collecting roller 26 is, for example, PFA. The charging roller 22 is a brush roller. The material of the brush is, for example, nylon.

In the third embodiment, similarly to the second embodiment, the charge eliminating sheet 23 is arranged to be in contact with the surface layer of the charging roller 22. The material of the charge eliminating sheet 23 is a conductive sheet. The charge eliminating sheet 23 is grounded to the main body frame or the like to which no bias is applied.

According to the third embodiment, the paper dust easily liberated from the sheet P is collected by the capturing roller 21. The paper dust is transferred from the capturing roller 21 to the collecting roller 26. The paper dust is scraped off from the collecting roller 26 by the blade 24 and collected into the container 25. As described above, since the paper dust is actively collected from the sheet P prior to passing through photosensitive drum 1, the amount of paper dust adhering to photosensitive drum 1 is reduced. As a result, an image defect or the like caused by paper dust or the like is less likely to occur.

In the third embodiment, the cleaning device 70 is included in the developing device 4, but this is merely an example. The cleaning device 70 may be secured to the main body frame of the image forming apparatus 500. Even in this case, the cleaning device 70 is disposed downstream of the sheet cassette 10 and upstream of photosensitive drum 1 in the conveyance direction of the sheet P.

### Fourth Embodiment

### (1) Overview

In the fourth embodiment, a cleaning device for cleaning dust on a floor is provided. An object to be cleaned is the floor, and an object to be captured (target to be collected) is the dust present on the floor. However, the cleaning principle of the fourth embodiment is the same as the cleaning principles of the first to third embodiments.

### (2) Cleaning Device

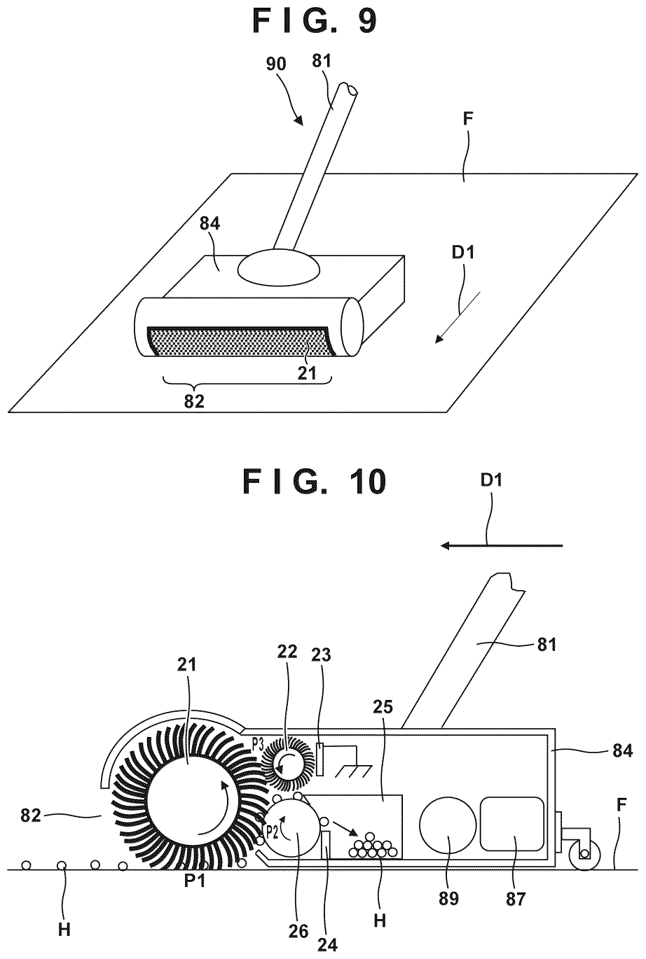

FIG. 9 shows appearance of a cleaning device 90 according to the fourth embodiment. The cleaning device 90 includes a housing 84 and a handle 81 coupled to the housing 84. An opening 82 is provided in front of the housing 84. The handle 81 is a grip portion gripped by a human user. The user moves the cleaning device 90 in a direction indicated by the arrow DI to rotate the capturing roller 21 provided inside the housing 84. The capturing roller 21 rotates while being in contact with a surface to be cleaned (for example, the floor F). As a result, a dust H that has entered through the opening 82 is collected into the housing 84.

FIG. 10 shows a schematic cross-section of the cleaning device 90. The dust H is scattered on the floor F. The structure of the cleaning device 90 of the fourth embodiment is basically the same as the structure of the cleaning device 20 of the first embodiment. The capturing roller 21 is disposed so as to face the floor F to be cleaned.

The charging roller 22 is disposed so as to face the capturing roller 21, and triboelectrically charges the capturing roller 21. The collecting roller 26 is disposed so as to face the capturing roller 21, and collects the dust H from the capturing roller 21 to the collecting roller 26. The charge eliminating sheet 23 is disposed so as to contact the charging roller 22, and the electric charges of the charging roller 22 are released to GND. The charge eliminating sheet 23 is connected to a frame ground (GND). The blade 24 collects the dust H from the collecting roller 26 to the container 25. The battery 87 supplies electric power to the motor 89. The motor 89 is, for example, a drive source that rotates the capturing roller 21, the charging roller 22, and the collecting roller 26.

The rotational direction of the capturing roller 21 is counterclockwise. The direction of rotation of the collecting roller 26 is clockwise. The rotational direction of the charging roller 22 is counterclockwise. That is, the moving direction of the contact portion of the capturing roller 21 and the moving direction of the contact portion of the collecting roller 26 are the same. The moving direction of the contact portion of the capturing roller 21 and the moving direction of the contact portion of the charging roller 22 are opposite each other.

Many of dust H present in nature are positively charged. Therefore, in the fourth embodiment, the capturing roller 21 is a brush roller as in the third embodiment.

The brush material is PET. The material of the surface layer 26a of the collecting roller 26 is PFA. The charging roller 22 is a brush roller. The brush material is nylon.

In the fourth embodiment, similarly to the second embodiment, the charge eliminating sheet 23 is arranged to be in contact with the surface layer of the charging roller 22. The material of the charge eliminating sheet 23 is a conductive sheet. The charge eliminating sheet 23 is grounded to a main body frame or the like to which no bias is applied.

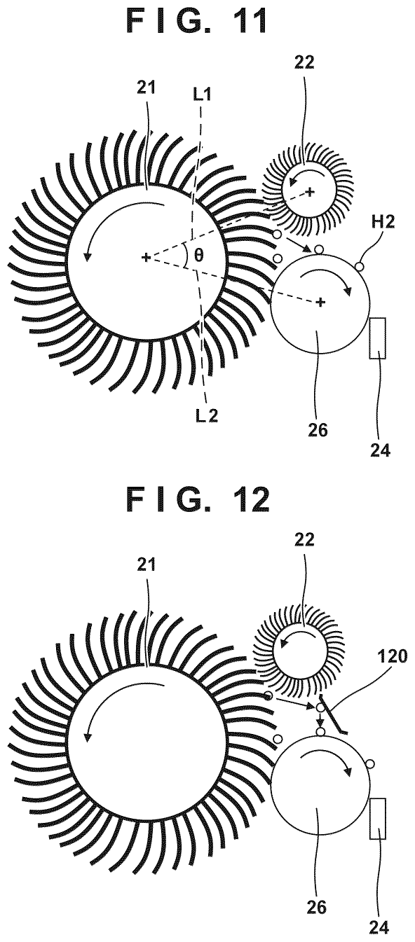

FIG. 11 shows a positional relationship between the capturing roller 21, the charging roller 22, the collecting roller 26, and the blade 24. In the fourth embodiment, an angle θ formed by a line L1 connecting a rotating shaft center of the capturing roller 21 and a rotating shaft center of the charging roller 22 and a line L2 connecting a rotating shaft center of the capturing roller 21 and a rotating shaft center of the collecting roller 26 is 30°.

The dust H collected by the capturing roller 21 is transferred from the capturing roller 21 to the collecting roller 26 by an electrostatic force. Ideally, more dust H is transferred to the collecting roller 26. However, the dust H may be fixed to the capturing roller 21 by non-electrostatic adherence (e.g., adhesion). Therefore, a part of the dust H may pass through the charging roller 22. Such part of the dust H is referred to as a dust H2. Since the charging roller 22 is reversely rotated with respect to the capturing roller 21, the dust H2 is separated from the capturing roller 21 and released by physical tapping. The dust H2 receives an electrostatic force and adheres to the collecting roller 26. This is because the collecting roller 26 is negatively charged with a larger amount of charge than the capturing roller 21. The dust H2 adhering to the collecting roller 26 is scraped off by the blade 24 and is accommodated in the container 25.

Here, the angle θ may be smaller than 90°. The angle θ may be smaller than 60°. For example, the angle θ is greater than or equal to 30° and smaller than 90°.

The dust H2 adhering to the capturing roller 21 may bounce off by the charging roller 22. With the illustrated angle θ, there is a greater probability that the dust H2 will bounce off in a trajectory that will directly reach the collecting roller 26. When the distance between the point where the dust H2 is released and the point where the dust H2 adheres to the collecting roller 26 becomes close, the electrostatic force greatly acts on the dust H2. These effects make it easier for the dust H2 to adhere to the collecting roller 26.

When the angle θ is 90° or more, these effects are not sufficiently performed, and the dust H2 is less likely to adhere to the collecting roller 26, and is likely to adhere to the capturing roller 21 again. Then, a part of the dust H2 adhering to the capturing roller 21 may pass through the charging roller 22 and re-adhere to the floor F. The dust H2 may obstruct the recovery of new dust H adhering on the floor F. The dust H2 may reduce the charge of the capturing roller 21 due to triboelectric charging with the charging roller 22. As a result, the recoverability of the dust H from the floor F may decrease.

As shown in FIG. 12, a guide plate 120 may be disposed between the charging roller 22 and the collecting roller 26. The guide plate 120 is a guide member that guides the dust H2 bounced off by the charging roller 22 to the collecting roller 26. This makes it easier for the dust H2 to adhere to the collecting roller 26.

### Others Embodiments

The first to fourth embodiments illustrate various applications to which the technical idea of the present disclosure can be applied. However, these are merely examples. For example, the cleaning devices 20, 70, 90 may be employed to clean dust adhering to the surface of a glass substrate or semiconductor wafer for display. The cleaning devices 20, 70, 90 may be employed to clean dust adhering to the surface of an electrostatic adsorption stage that holds these substrates in a vacuum chamber of a semiconductor manufacturing apparatus.

The capturing roller 21 is an example of a rotatable capturing rotation member that captures an object to be captured on a surface to be cleaned by static electricity.

The charging roller 22 is an example of a charging rotation member that rotates while being in contact with the capturing roller 21 and triboelectrically charges the peripheral surface of the capturing roller 21. The collecting roller 26 is an example of a collecting rotation member that rotates while in contact with the capturing roller 21, and collects the captured object that adheres to the peripheral surface of the capturing roller 21. As illustrated in FIG. 2 and the like, the capturing roller 21 and the surface to be cleaned contact with each other in the first position P1 in the rotational direction of the capturing roller 21. The capturing roller 21 and the collecting roller 26 contact at the second position P2. The capturing roller 21 and the charging roller 22 contact at the third position P3. The first position P1 is upstream of the second position P2. The second position P2 is upstream of the third position P3. That is, the first position P1, the second position P2, and the third position P3 are arranged in order along the rotational direction of the capturing roller 21. The rotational direction of the capturing roller 21 is the same as the rotational direction of the charging roller 22. The rotational direction of the capturing roller 21 is opposite to the rotational direction of the collecting roller 26. As a result, the capturing roller 21 can be sufficiently charged without using an expensive high-voltage power supply. As a result, the object to be captured can be collected with a simpler structure.

The core member 21b is an exemplary rotating shaft provided with a capturing brush 21a.

The core member 22b is an exemplary rotating shaft provided with a charging brush 22a.

In the triboelectric series, the material forming the outer peripheral of the collecting rotation member may be more easily charged positively than the material forming the outer peripheral of the capturing rotation member, and the material forming the outer peripheral of the capturing rotation member may be more easily charged positively than the material forming the outer peripheral of the charging rotation member. As a result, the object to be captured, which is negatively charged, can be accurately collected. For example, the negatively charged toner T is accurately collected.

In the triboelectric series, the material forming the outer peripheral of the collecting rotation member may be more likely to be negatively charged than the material forming the outer peripheral of the capturing rotation member, and the material forming the outer peripheral of the capturing rotation member may be more likely to be negatively charged than the material forming the outer peripheral of the charging rotation member. As a result, the positively charged object to be captured can be effectively collected. For example, the positively charged toner T or dust His effectively collected.

The moving speed of the peripheral surface of the collecting rotation member may be higher than the moving speed of the peripheral surface of the capturing rotation member. This will improve the transferability of the material to be collected from the capturing roller 21 to the collecting roller 26.

As illustrated in FIG. 11, the dust H2 tapped off from the capturing roller 21 by the charging roller 22 may be easily directed toward the collecting roller 26. The charge eliminating sheet 23 is an example of a charge eliminating member that neutralizes the surface of the charging roller 22. As a result, the charging performance of the charging roller 22 is improved, and the capturing roller 21 is sufficiently charged.

The charge eliminating sheet 23 is an example of a grounded conductive plate or sheet.

As illustrated in FIG. 12, the guide plate 120 is an example of a guide member that is provided between the charging roller 22 and the collecting roller 26 and guides the objet to be collected to the collecting roller 26. As a result, the object to be captured is more likely to be guided to the collecting roller 26.

The peripheral surface of the intermediate transfer belt 7 is an example of a surface to be cleaned.

As shown in FIG. 6, the peripheral surface of the photosensitive drum 1 is an exemplary surface to be cleaned.

As described with reference to FIG. 8, the surface (image forming surface) of the sheet P is an example of a surface to be cleaned.

The intermediate transfer belt 7 and photosensitive drum 1 are an exemplary image forming unit. The peripheral surface of the intermediate transfer belt 7 and the peripheral surface of photosensitive drum 1 are exemplary surfaces to be cleaned in the image forming unit.

As shown in FIG. 8, the cleaning device 80 is an example of a first cleaning unit. As illustrated in FIGS. 2 and 6, the cleaning device 20 is an example of a second cleaning unit.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-186953, filed Oct. 31, 2023 which is hereby incorporated by reference herein in its entirety.

What is claimed is:

1. A cleaning device comprising:
a capturing rotation member that is rotatable and configured to capture an object to be captured on a surface to be cleaned by static electricity;
a charging rotation member that rotates while being in contact with the capturing rotation member and configured to triboelectrically charge a peripheral surface of the capturing rotation member; and
a collecting rotation member that rotates while in contact with the capturing rotation member and configured to collect the object to be captured that adhered to the peripheral surface of the capturing rotation member,
wherein in a rotational direction of the capturing rotation member, the capturing rotation member contacts the surface to be cleaned at a first position,
in the rotational direction of the capturing rotation member, the capturing rotation member and the collecting rotation member are in contact at a second position,
in the rotational direction of the capturing rotation member, the capturing rotation member and the charging rotation member are in contact at a third position,
the first position, the second position, and the third position along the rotational direction of the capturing rotation member are arranged in order, the rotational direction of the capturing rotation member is the same as a rotational direction of the charging rotation member, and
the rotational direction of the capturing rotation member is opposite to a rotational direction of the collecting rotation member.

2. The cleaning device according to claim 1, wherein
the capturing rotation member comprises:
a capturing brush; and
a rotating shaft provided with the capturing brush.

3. The cleaning device according to claim 1, wherein
the charging rotation member comprises:
a charging brush; and
a rotating shaft provided with the charging brush.

4. The cleaning device according to claim 1, wherein
in a triboelectric series, a material forming an outer peripheral of the collecting rotation member is more easily charged positively than a material forming an outer peripheral of the capturing rotation member, and the material forming the outer peripheral of the capturing rotation member is more easily charged positively than a material forming an outer peripheral of the charging rotation member.

5. The cleaning device according to claim 1, wherein
in a triboelectric series, a material forming an outer peripheral of the collecting rotation member is more likely to be negatively charged than a material forming an outer peripheral of the capturing rotation member, and the material forming the outer peripheral of the capturing rotation member is more likely to be negatively charged than a material forming an outer peripheral of the charging rotation member.

6. The cleaning device according to claim 1, wherein
a moving speed of a peripheral surface of the collecting rotation member is higher than a moving speed of a peripheral surface of the capturing rotation member.

7. The cleaning device according to claim 1, wherein
an angle formed by a first straight line connecting a rotational center of the capturing rotation member and a rotation center of the charging rotation member and a second straight line connecting the rotation center of the capturing rotation member and a rotation center of the collecting rotation member is smaller than 90° and equal to or greater than 30°.

8. The cleaning device according to claim 1, further comprising
a charge eliminating member configured to eliminates charge on a surface of the charging rotation member.

9. The cleaning device according to claim 8, wherein
the charge eliminating member includes a grounded conductive plate or sheet.

10. The cleaning device according to claim 1, further comprising
a guide member provided between the charging rotation member and the collecting rotation member, and guides the object to be captured to the collecting rotation member.

11. The cleaning device according to claim 1, wherein
the surface to be cleaned is a peripheral surface of an intermediate transfer member provided in an image forming apparatus.

12. The cleaning device according to claim 1, wherein
the surface to be cleaned is a peripheral surface of a transfer material conveyance member that conveys a transfer material in an image forming apparatus.

13. The cleaning device according to claim 1, wherein
the surface to be cleaned is a peripheral surface of an image carrier provided in an image forming apparatus.

14. The cleaning device according to claim 1, wherein
the surface to be cleaned is a surface of a transfer material on which an image is formed in an image forming apparatus.

15. The cleaning device according to claim 1, wherein
the surface to be cleaned is a surface of a glass substrate for a display.

16. The cleaning device according to claim 1, wherein
the surface to be cleaned is a surface of a semiconductor wafer.

17. The cleaning device according to claim 1, wherein
the surface to be cleaned is a surface of an electrostatic attraction stage provided in a semiconductor manufacturing apparatus.

18. The cleaning device according to claim 1, wherein
the object to be captured is dust.

19. An image forming apparatus comprising:
a conveyance roller configured to convey a sheet;
a first cleaning unit configured to clean the sheet;
an image forming unit configured to form an image on the sheet cleaned by the first cleaning unit; and
a second cleaning unit configured to clean the image forming unit, wherein the first cleaning unit comprises:
a first capturing rotation member that is rotatable and configured to capture an object to be captured on the sheet by static electricity;
a first charging rotation member that rotates while being in contact with the first capturing rotation member and configured to triboelectrically charge a peripheral surface of the first capturing rotation member; and
a first collecting rotation member that rotates while in contact with the first capturing rotation member and configured to collect the object to be captured that adhered to the peripheral surface of the first capturing rotation member,
in a rotational direction of the first capturing rotation member, the first capturing rotation member and the sheet are in contact at a first position,
in the rotational direction of the first capturing rotation member, the first capturing rotation member and the first collecting rotation member are in contact at a second position,
in the rotational direction of the first capturing rotation member, the first capturing rotation member and the first charging rotation member are in contact at a third position,
the first position, the second position, and the third position along the rotational direction of the first capturing rotation member are arranged in order,
the rotational direction of the first capturing rotation member is the same as a rotational direction of the first charging rotation member,
the rotational direction of the first capturing rotation member is opposite to a rotational direction of the first collecting rotation member,
the second cleaning unit comprises:
a second capturing rotation member that is rotatable and configured to capture an object to be captured on a surface to be cleaned in the image forming unit by static electricity;
a second charging rotation member that rotates while being in contact with the second capturing rotation member to triboelectrically charge a peripheral surface of the second capturing rotation member; and
a second collecting rotation member that rotates while in contact with the second capturing rotation member and collects the object to be captured that adhered to the peripheral surface of the second capturing rotation member,
wherein in a rotational direction of the second capturing rotation member, the second capturing rotation member contacts the surface to be cleaned at a fourth position,
in the rotational direction of the second capturing rotation member, the second capturing rotation member and the second collecting rotation member are in contact at a fifth position,
in the rotational direction of the second capturing rotation member, the second capturing rotation member and the second charging rotation member are in contact at a sixth position,
the fourth position, the fifth position, and the sixth position along the rotational direction of the second capturing rotation member are arranged in order,
the rotational direction of the second capturing rotation member is the same as a rotational direction of the second charging rotation member, and
the rotational direction of the second capturing rotation member is opposite to a rotational direction of the second collecting rotation member.

20. A cleaning device comprising:
a capturing rotation member that is rotatable and configured to capture an object to be captured on a surface to be cleaned by static electricity;
a charging rotation member that is in contact with the capturing rotation member and is configured to triboelectrically charge a peripheral surface of the capturing rotation member; and
a collecting rotation member that rotates while being in contact with the capturing rotation member and collects the object to be captured that adhered to the peripheral surface of the capturing rotation member,
wherein in a rotational direction of the capturing rotation member, the capturing rotation member contacts the surface to be cleaned at a first position,
in the rotational direction of the capturing rotation member, the capturing rotation member and the collecting rotation member are in contact at a second position,
in the rotational direction of the capturing rotation member, the capturing rotation member and the charging rotation member are in contact at a third position,
a charge polarity of the object to be captured is a first polarity, and
in a triboelectric series, a material of the capturing rotation member is more likely to be charged to a second polarity than a material of the charging rotation member, and a material of the collecting rotation member is more likely to be charged to the second polarity than the material of the capturing rotation member.
